(19) United States
(12) Patent Application Publication
(10) Pub. No.: US 2004/0088319 A1
(43) Pub. Date: May 6, 2004

(54) Data Processor

(75) Inventors: Takanaga Yamazaki, Tama (JP); Yuichi Abe, Mito (JP); Kesami Hagiwara, Higashiyamato (JP); Yasuo Sugure, Hachioji (JP); Takeshi Kataoka, Tokyo (JP); Seiji Takeuchi, Higashimurayama (JP); Satoshi Tanaka, Tachikawa (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/686,701

(22) Filed: Oct. 17, 2003

(30) Foreign Application Priority Data
Oct. 30, 2002 (JP) 2002-315292

(51) Int. Cl. G06F 17/00

(52) U.S. Cl. 707/102

(57) ABSTRACT

A data processor of the present invention reduces the program code size of a program for saving and restoring plural registers. The data processor includes a plurality of registers usable for instruction execution and has an instruction set including predetermined data transfer instructions. The predetermined data transfer instructions have register specification fields of plural bits in which the number of one register is explicitly specified from a group of registers, and specify data transfers between registers corresponding to numbers equal to or greater than, or equal to or smaller than a number specified in the register specification field and memory. A plurality of registers of the group of registers, specified in one operand, can be saved to and restored from memory. The program code size of a program for saving and restoring plural registers can be reduced. Since the predetermined instructions have only one operand, they can fit easily in 16 bits.

### BACKGROUND OF THE INVENTION

The present invention relates to data transfer technology in data processing devices, and more particularly to save and restore operations on registers and the like within a CPU (central processing unit), and technology effectively applied to program-incorporating microcomputers.

During a function call and an interrupt, CPU registers used in a routine concerned are saved to a stack at the start of the routine and restored from the stack at the last of the routine. The save and restore operations have been performed by transfer instructions for each of the registers. As a result, transfer instructions for all registers to be saved and restored are required, increasing program size (code size).

According to technology described in Patent Publication 1, save and restore instructions have instruction code for specifying general purpose registers, combinations of which are specified to be continuous. The number of registers that are specified to be continuous depends on operation code, and combinations of registers that are specified to be continuous can be selected by an operand.

According to a data processor described in Patent Publication 2, the data processor includes a means for specifying general purpose registers to be saved when an interrupt occurs, and saves the specified general purpose registers to memory. The general purpose registers to be saved are specified with an n-bit register specification field for n number of general purpose registers, and the n number of general purpose registers that are arbitrarily specified can be saved and restored.

According to technology described in Patent Publication 3, a stack pointer is assigned to part of general purpose registers, and the number of registers to be saved to and restored from one bank block is made variable. As one example, one of 16 general purpose registers of 16 bits each is assigned to a stack pointer which can access 64 k bytes, and the remaining 15 are made usable as general purpose registers. As another example, two of 16 general purpose registers of 16 bits each are assigned to a stack pointer which can access 4G bytes, and the remaining 14 are made usable as general purpose registers.

[Patent Publication 1]

Japanese Unexamined Patent Publication No. 2002-157115

[Patent Publication 2]

Japanese Unexamined Patent Publication No. Hei5(1993)-6281

[Patent Publication 3]

Japanese Unexamined Patent Publication No. Hei5(1993)-334100

### SUMMARY OF THE INVENTION

According to the technology described in Patent Publication 1, the number of registers that can be saved and restored is limited, such as 2, 3, and 4, and combinations of them are also limited; an increase in combinations requires a corresponding increase in the types of operation codes.

As described in Patent Publication 2, if whether to save and restore registers is specified by a bit for each of the registers, many fields will be required in an instruction format, and instruction length will be unable to be shortened, reducing the effect of reducing program size. An attempt to shorten instruction length would shorten the field of operation code, with the result that save/restore instructions would take up a large area on the code map of operation code.

In the Patent Publication 3, reduction in the program size of a program for saving and restoring general purpose registers is not taken into account.

An object of the present invention is to provide a data processor that can reduce the program size of a program for saving and restoring plural registers.

Another object of the present invention is to provide a data processor that can save and restore plural registers, using instructions capable of specifying plural registers by one operand.

Another object of the present invention is to provide a data processor that contributes to higher speed data processing by efficiently saving and restoring plural registers.

The foregoing and other objects, and novel features of the present invention will become apparent from this specification and the accompanying drawings.

Representative examples of the invention disclosed in the present application will be briefly described below.

[1] A data processor according to the present invention has plural registers usable to instruction execution and has an instruction set containing predetermined data transfer instructions. The predetermined data transfer instructions have a register specification field of plural bits in which the number of one register is explicitly specified from a group of registers, and specify data transfers between registers corresponding to numbers equal to or greater than, or equal to or smaller than a number specified in the register specification field and memory. The group of registers is, e.g., general purpose registers and a procedure register.

For example, when a group of registers is R0 to Rn and the numbers of the registers are 0 to n, if register number i is specified in the register specification field of the predetermined data transfer instructions, Ri to Rn or Ri to R0 are saved or restored depending on the operation code to transfer data to and from memory. The correspondence between the types of actual registers and numbers specified in the register specification field is determined by the logic of an instruction decoder or the like. Accordingly, register numbers 0 to n do are not required to be assigned to the general purpose registers R0 to Rn; register numbers 0 to j may be assigned to registers R0 to Rj, which are part of the general purpose registers R0 to Rn, and register numbers j+1 to n may be assigned to predetermined registers other than the general purpose registers R0 to Rn.

According to the above-described means, plural registers of the group of registers, specified in one operand, can be saved to and restored from memory. Accordingly, the program code size of a program for saving and restoring plural registers can be reduced. Since the predetermined instructions have only one operand, they can fit easily in 16 bits. Since the program code size of a program for saving and restoring plural registers can be reduced, data processing efficiency for saving and restoring plural registers increases, contributing to higher speed data processing. Specifically, although save and restore operations by plural transfer instructions have required time for instruction fetching, since plural registers can be saved or restored by one instruction of short bit length, time required for instruction fetching can be eliminated, contributing to a higher execution speed.

The above-described means employs instructions to save and restore registers having numbers equal to or greater than, or equal to or smaller than a number specified in one operand of instructions. Accordingly, it is impossible to subject only registers in the middle of numbers specifiable in the register specification field to data transfer. This limitation does not sacrifice the operability of save and restore operations. This is because, in register management of compilers, commonly, the register numbers of registers (destroyed in subroutines and interrupt service routines) to be saved and restored are managed so as to be continuous in ascending order or descending order.

In considering reduction in program code size, even though 4 bits are assigned to a register specification field, operation code can use 12 bits. In this case, one 16-bit instruction consumes a scant 1/4096 the entire code map. Yet, the number of registers that can be specified to be saved and restored is 16 at the maximum. On the other hand, if the technology of the Patent Publication 2 is adopted, in a case where a register specification field is 12 bits, it is not realistic that the number of registers that can be specified to be saved and restored is 12 at the maximum and still one 16-bit instruction consumes 1/16 the entire code map. If, in the technology of the Patent Publication 2, arrangements are made so that one 16-bit instruction consumes a scant 1/4096 the entire code map, the number of specifiable registers would in turn decrease to 4 at the maximum. Accordingly, even in a CPU having a short instruction length, the predetermined data transfer instructions can be added to the instruction set without decreasing the number of instruction types.

By reducing program code size, the area of on-chip program memory can be reduced. This is because plural data transfer instructions become unnecessary since plural registers can be saved and restored by one instruction, and operation code can be lengthened and instruction length can be shortened since plural registers to be saved and restored can be specified by one operand (4 bits). Since on-chip program memory has relatively large storage capacity limitations, in this sense, the present invention is suitable for data processors having on-chip program memory. The on-chip program memory may be mask ROM or erasable PROM such as flash memory.

As an embodiment of the present invention, the predetermined data transfer instructions have register indirectly addressing mode. A register used in the register indirectly addressing mode is incremented or decremented for each transfer between the register and memory. A register used in the register indirectly addressing mode is, e.g., a stack pointer. The predetermined data transfer instructions are used for save and restore operations performed during subroutine call and interrupt.

As an embodiment of the present invention, examples of the predetermined data transfer instructions are: a first store instruction specifying data transfers to memory from registers corresponding to numbers equal to or greater than a number specified in a register specification field as a starting point; a first load instruction specifying data transfers from memory to registers corresponding to numbers equal to or greater than a number specified in a register specification field as a starting point; a second store instruction specifying data transfers to memory from registers corresponding to numbers equal to or smaller than a number specified in a register specification field as a starting point; or a second load instruction specifying data transfers from memory to registers corresponding to numbers equal to or smaller than a number specified in a register specification field as a starting point.

[2] According to another aspect of the present invention, a data processor includes an instruction control part for decoding instructions and controlling instruction execution sequences, and plural registers, wherein the instruction control part, when decoding a number specified in a register specification field of plural bits paired with specific operation code, controls data transfers between registers corresponding to numbers equal to or greater than, or equal to or smaller than the number, and memory. Plural registers of a group of registers, specified in one operand, can be saved to and restored from memory.

In an embodiment of the present invention, the instruction control part can change the correspondence between numbers specifiable in the register specification field and registers according to setting states of a control register. Specifically, the decode logic of the register field is made variable. Accordingly, the types of registers specified by numbers equal to or smaller than, or equal to or greater than a number specified in the register specification field become variable.

A group of registers specifiable by numbers of the register specification field may be general purpose registers, and one or plural registers selected from a group of special-purpose registers other than the general purpose registers within the data processor, such as procedure register, vector register, and product-sum operation register.

### BRIEF DESCRIPTION OF THE DRAWINGS

FIG. 1 is a diagram illustrating load-multi/store-multi instructions and their functions;

FIG. 2 is a diagram illustrating the instruction codes of the instructions shown in FIG. 1;

FIG. 3 is a diagram illustrating a correspondence between numbers specified in a register specification field, and registers subject to save and restore operations, corresponding to the numbers;

FIG. 4 is a block diagram showing a data processor according to an embodiment of the present invention; and

FIG. 5 is a block diagram showing an example of CPU.

### DESCRIPTION OF THE PREFERRED EMBODIMENTS

<<The Whole of a Data Processor>>

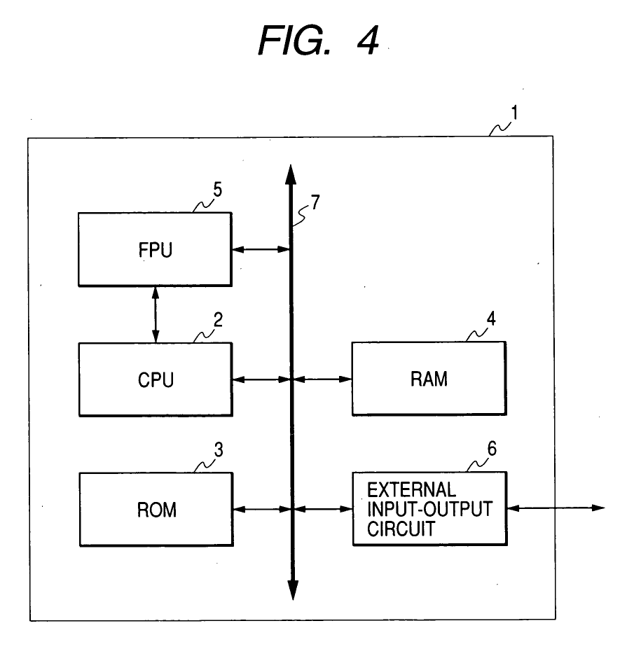

FIG. 4 shows a data processor according to an embodiment of the present invention. The data processor 1, though not specially limited, includes CPU 2, ROM (read only memory) 3, RAM (random access memory) 4, and external input-output circuit 6; these circuit modules share an internal bus 7. The internal bus 7 comprises buses for addresses, data, and control signals. A floating-point operation unit (FPU) 5 is connected to the CPU 2.

The RAM 4 is used as a work area of the CPU 2 or an area for temporarily storing data. The ROM 3 holds operation programs of the CPU 2. The ROM 3 comprises a mask ROM or electrically erasable flash memory. The external input-output circuit 6 comprises a timer counter, a serial input-output circuit, an input-output port, and the like.

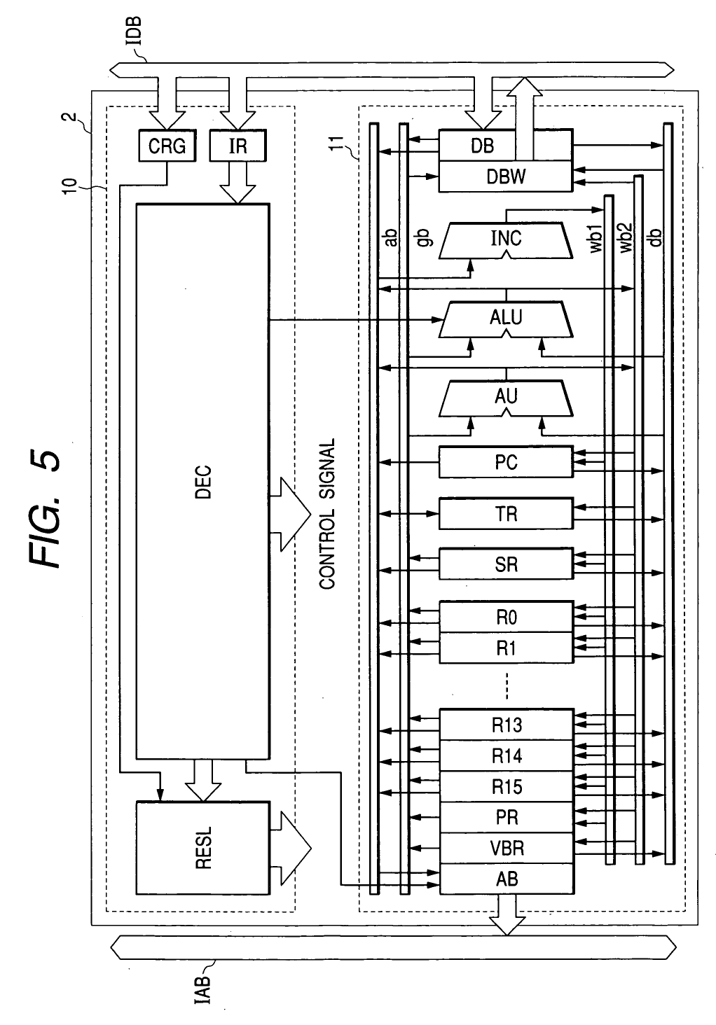

FIG. 5 shows an example of the CPU 2. The CPU 2 comprises an instruction control part 10 and an execution part 11.

The instruction control part 10 includes an instruction register IR, an instruction decoder DEC, a register selector RESL, and a control register CRG. An instruction to be executed is fetched to the instruction register IR. The instruction decoder DEC decodes an instruction fetched to the instruction register IR, controls instruction execution procedures such as instruction fetch and branch control, and performs operation control over the execution part 11 and the like. A register specified in a register specification field included in an instruction is selected by a register selector RESL. A register selection logic by the register selector RESL has functions which are fixed or changeable depending on setting states of the control register CRG.

The execution part 11 includes general purpose registers R0 to R15, a program counter PC, a status register SR, a temporary register TR, a procedure register PR, an arithmetic logic unit ALU, an incrementer INC, an address operation unit AU, a read data buffer DBR, a write data buffer DBW, an address buffer AB, and a vector base register VBR; these circuit blocks are mutually connected by internal buses ab, gb, db, wb1, and wb2. The execution part 11 is connected to a data bus IDB and an address bus IAB included in the internal bus 7.

The general purpose registers R0 to R15 can be used both as address registers and data registers. The general purpose register R15 has functions of a stack pointer (SP) as well as functions of a general purpose register. During an interrupt and a subroutine call, a return address and general purpose registers are saved to and restored from a stack area, using the stack pointer (SP). The save and restore operations will be described in detail later. Interrupt service is used as a concept including exception handling as well.

The program counter PC is a 32-bit counter which points to the address of an instruction executed by the CPU 2. The status register SR is a 32-bit register indicating the status of the CPU 2. The vector base register VBR is used as a high-order address during reading of an exception handling vector table. The procedure register PR stores a return address during a subroutine call.

The arithmetic logic unit ALU is used for arithmetic logic operations specified by instructions. The address operation unit AU is used to compute effective addresses. The incrementer INC is used for addition and other operations on the program counter PC.

An instruction fetch address and an operand access address are outputted from the address buffer AB to the internal address bus IAB. An instruction specified by the instruction fetch address is fetched to the instruction register IR through the internal data bus IDB from the ROM 3. The RAM specified by an operand access address outputted to the internal address bus IAB, and registers of the external input-output circuit are read and written through the internal data bus IDB.

<<Save and Restore by Load/Store Instruction>>

A description is made of save and restore operations by load/store instructions when a subroutine call occurs in a program being processed by the CPU 2 of the data processor 1. The load/store instruction used here is a 16-bit data transfer instruction that has a register indirectly addressing mode and has an operand to specify one register.

A return address from a subroutine is stored in the procedure register PR. If the subroutine further calls another subroutine, since the procedure register PR would be overwritten, the procedure register PR is saved to a stack area at the start of the subroutine. An instruction in this case is written as follows, for example,

MOV.L PR, @-R15.

This instruction subtracts four addresses from the value of the stack pointer R15 and stores the result in the stack pointer R15, and stores the value of the procedure register PR in the address location.

Furthermore, since the use of registers within the subroutine means destruction of the registers to a calling side (main routine side), general purpose registers must be saved at the start of the subroutine. For example, the following processing is performed:

MOV.L R0, @-R15

MOV.L R1, @-R15 . . .

MOV.L R14, @-R15

As a result, the values of general purpose registers R0 to R14 are saved to memory addresses pointed to by the stack pointer R15 successively updated.

For return from the subroutine to the main routine, the saved registers must be restored. For example, the following processing is performed.

MOV.L @R15+, R14 . . .

MOV.L @R15+, R1

MOV.L @R15+, R0

MOV.L @R15+, PR

The first instruction loads read data at an address pointed to by the stack pointer R15 into the general purpose register R14 and increases the value of the stack pointer R15 by four addresses to write the value back to the stack pointer R15.

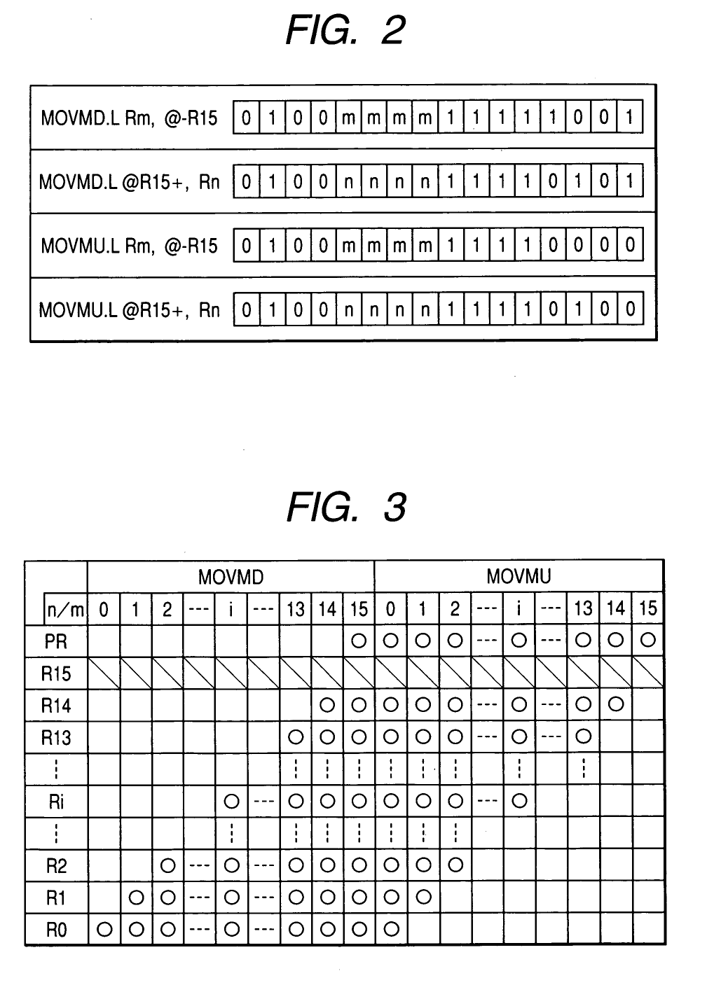

Such save and restore operations are performed in the same way at the entrance and exit of an interrupt service routine. As a memory used as a stack area, the internal RAM 4 of FIG. 2 or an external RAM (not shown) connected to the external input-output circuit 6 is used.

<<Save and Restore by Load-Multi/Store-Multi Instruction>>

An instruction set of the CPU 2 includes a load-multi/store-multi instruction, which is a data transfer instruction having a small 4-bit operand for specifying plural registers that can perform the same processing as the above-described save and restore operations.

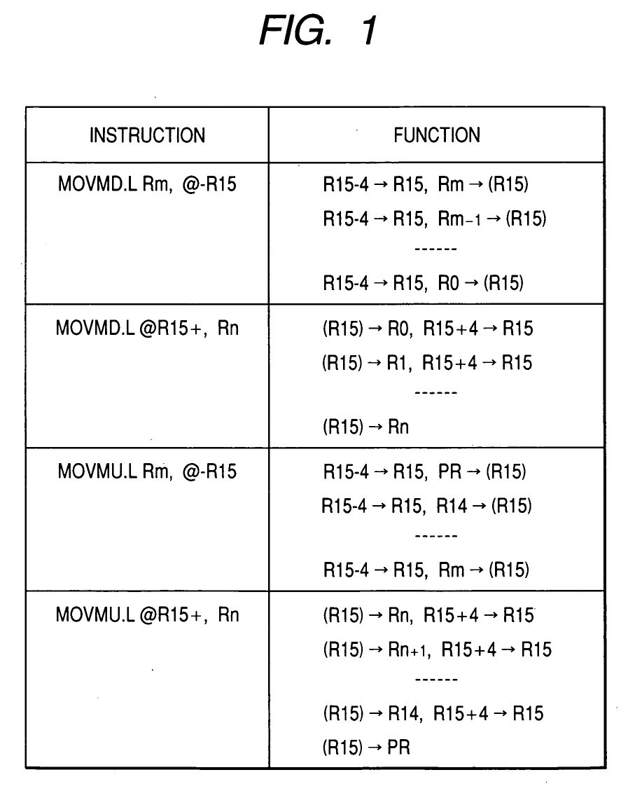

FIG. 1 shows load-multi/store-multi instructions and their functions. FIG. 2 shows instruction codes of the instructions shown in FIG. 1.

The load-multi/store-multi instruction are broadly classified into a MOVMD instruction and a MOVMU instruction.

The MOVMD instruction, which is an instruction transferring a source operand to a destination, performs transfers between registers corresponding to numbers equal to or smaller than a number specified in a register specification field and memory addressed by the contents of R15. An addressing mode for memory is a register indirectly addressing mode. An instruction with register Rm as source performs a save operation on the register, and an instruction with register Rn as destination performs a restore operation on the register. Save operations are performed for registers of successive smaller numbers, beginning with the number of specified Rm. Restore operations are performed beginning with the smallest register number R0. A save operation sets the memory address of stack area to four addresses smaller than the value of R15 (@-R15), while a restore operation increases its memory address by four addresses (@R15+). An address specification field has four bits like mmmm and nnnn shown in FIG. 2, and Rn and Rm can assume numbers from 0 to 15; 0 denotes save and restore operations on only R0, 1 denotes save and restore operations on R0 and R1, and 14 denotes save and restore operations on R0 to R14. When 15 is specified, the procedure register PR in addition to R0 to R14 is saved and restored. R15 used as a stack pointer is excluded from save and restore operations. A correspondence between numbers specified in the register specification field, and registers subject to save and restore operations, corresponding to the numbers, is as shown in FIG. 3. Registers subject to save and restore operations with respect to numbers (n or m) explicitly specified are marked with a circle (∘).

The MOVMU instruction, which is an instruction transferring a source operand to a destination, performs transfers between registers corresponding to numbers equal to or greater than a number specified in the register specification field and memory addressed by the contents of R15. An addressing mode for memory is a register indirectly addressing mode. An instruction with register Rm as source performs a save operation on the register, and an instruction with register Rn as destination performs a restore operation on the register. Save operations are performed for registers of successive smaller numbers, beginning with the procedure register PR having the largest number. Restore operations are performed for registers of successive larger numbers, beginning with the number of specified Rn. A save operation sets the memory address of stack area to four addresses smaller than the value of R15 (@-R15), while a restore operation increases its memory address by four addresses (@R15+). An address specification field has four bits like mmmm and nnnn shown in FIG. 2, and Rn and Rm can assume numbers from 0 to 15; 0 denotes save and restore for R0 to R14, and PR, 1 denotes save and restore for R1 to R14, and PR, and 14 denotes save and restore for R14 and the procedure register PR. When 15 is specified, the procedure register PR are saved and restored. R15 used as a stack pointer is excluded from save and restore operations. A correspondence between numbers specified in the register specification field, and registers subject to save and restore operations, corresponding to the numbers, is as shown in FIG. 3.

Instructions of this example are 16 bits long and each instruction code includes only one operand, which is a 4-bit register number specification field. All the remaining 12 bits are only operation code. Accordingly, the instructions consume a scant 1/4096 the entire code map of 16-bit instruction code.

Since one instruction is 16 bits long, program code size can be reduced.

Generally in the C compiler, registers are used in limited ways within its subroutines (functions); they are often used in ascending order or descending order of number. Rarely, variables are allocated to registers of random numbers. The method of specifying several ascending or descending register numbers suffices for the saving and restoring of plural registers of CPU based on the C compiler.

Referring to FIG. 5, the execution of load-multi/store-multi instructions will be described.

(1) MOVMD.L Rm, @-R15

In this instruction, Rm assumes one of 0 to 15 as a number m. The instruction decoder DEC, by decoding the instruction, initializes an internal counter i to m. i is decremented by 1 until it reaches 0 (i=m□0; i−−). First, the value of stack pointer R15 is decremented by 4 in the address operation unit AU, and the decremented value is outputted as a memory address from the address buffer AB and written back to the stack pointer R15. If i<15, a register value is fetched from register Ri, and otherwise (i=15) from the procedure register PR, and the register value is supplied to the RAM 4 via the write data buffer DBW. Each time one register is saved, i is decremented and the above save operation is repeated until i reaches 0.

(2) MOVMD.L @R15+, Rn

In this instruction, Rn assumes one of 0 to 15 as a number n. The instruction decoder DEC, by decoding the instruction, initializes an internal counter i to 0. i is incremented by 1 until it reaches n (i=0□n; i++). First, the value of stack pointer R15 is fetched and outputted as a memory address from the address buffer AB, and a value produced by incrementing the fetched stack pointer value by 4 in the address operation unit AU is written back to the stack pointer R15. A value read from the RAM 4 by the memory address is restored to register Ri or the procedure register PR. If i<15, memory data is stored in register Ri, and otherwise (i=15) in the procedure register PR. Each time one register is restored, i is incremented and the above restore operation is repeated until i reaches n.

(3) MOVMU.L Rm, @-R15

In this instruction, Rm assumes one of 0 to 15 as a number m. The instruction decoder DEC, by decoding the instruction, initializes an internal counter i to 15. i is decremented by 1 until it reaches m (i=15□m; i−−). First, the value of stack pointer R15 is decremented by 4 in the address operation unit AU, and the decremented value is outputted as a memory address from the address buffer AB and is written back to the stack pointer R15. If i<15, a register value is fetched from register Ri, and otherwise (i=15) from the procedure register PR, and supplied to the RAM 4 via the write data buffer DBW. Each time one register is saved, i is decremented and the above save operation is repeated until i reaches m.

(4) MOVMU.L @R15+, Rn

In this instruction, Rn assumes one of 0 to 15 as a number n. The instruction decoder DEC, by decoding the instruction, initializes an internal counter i to n. i is incremented by 1 until it reaches 15 (i=n□15; i++). First, the value of stack pointer R15 is fetched and outputted as a memory address from the address buffer AB, and a value produced by incrementing the fetched stack pointer R15 value by 4 in the address operation unit AU is written back to the stack pointer R15. A value read from the RAM 4 by the memory address is restored to register Ri or the procedure register PR. If i<15, memory data is stored in register Ri, and otherwise (i=15) in the procedure register PR. Each time one register is restored, i is incremented and the above restore operation is repeated until i reaches n.

<<Change of Registers to be Saved or Restored>>

The CPU 2 of FIG. 5 has the control register CRG, and register selection logics by the register selector RESL are made variable depending on the setting state of the control register CRG. In the initial state of the control register CRG, which is a state initialized by power-on reset, registers to be saved and restored in load-multi/store-multi instructions are the general purpose registers R0 to R14 and the procedure register. This is changed by changing the value of the register CRG according to predetermined rules. For example, the logic of bringing the register numbers 0 to 14 into correspondence with R0 to R14 may be changed to the logic of bringing the register numbers 0 to 7 into correspondence with R7 to R14 and the register numbers 8 to 14 into correspondence with R0 to R6. In this way, if the correspondence between register numbers and actual registers can be freely changed by a special-purpose register such as CRG, instructions to save and restore plural registers by continuous number specification will be able to save and restore any combinations of registers.

Hereinbefore, the invention made by the inventors has been described in detail based on embodiments. It goes without saying that the present invention is not limited to the embodiments and may be changed in various ways without departing from the spirit and scope of the present invention.

For example, instructions to save and restore plural registers have targeted only the general purpose registers R0 to R14 and the return destination register PR. The actual CPU includes, in addition to them, various registers such as special-purpose pointers (global base register GBR, vector base register VBR, etc.) and accumulators (product-sum operation register MAC). To save and restore these register as well, they can be assigned to any of the register numbers 0 to 15 by the CRG. As another method, register numbers specified in the register specification field may be extended from 4-bit specification to 5-bit specification. In this case, a register number 16 is used as GBR and 17 as VBR.

Data processors installed with the FPU for floating-point operations as a coprocessor, in some cases, also require saving and restoring floating-point data storage registers. This can also be achieved as FPU-specific instructions in the same way as saving and restoring plural floating-point registers like the present invention. Or this can also be achieved by specifying CRG or extending the register specification field in the above-described MOVMD and MOVMU instruction group.

Circuit modules of the data processor, without being limited to the above-described embodiments, can be changed as required. For example, there may be provided with cache memories such as data cache and instruction cache, and USB and other peripheral circuits. The data processor according to the present invention can be incorporated in equipment such as printer to control it and can be used as a general-purpose processor.

Effects obtained by representative examples of the invention disclosed in this application will be briefly described.

Plural registers of a group of registers can be specified in one operand to save and restore them to and from memory. As a result, the program code size of a program for saving and restoring plural registers can be reduced. Since the number of operands is one, instructions fit easily in 16 bits. Since the program code size of a program for saving and restoring plural registers can be reduced, data processing efficiency for saving and restoring plural registers increases, contributing to higher speed data processing.

What is claimed is:

1. A data processor including a plurality of registers usable for instruction execution and having an instruction set including a plurality of predetermined data transfer instructions,
wherein the predetermined data transfer instructions include a register specification field of plural bits in which the number of one register is explicitly specified from a group of registers, and
wherein the predetermined data transfer instructions specify data transfers between registers corresponding to numbers equal to or greater than, or equal to or smaller than a number specified in the register specification field and memory.

2. The data processor according to claim 1,
wherein the group of registers includes general purpose registers.

3. The data processor according to claim 2,
wherein the group of registers includes a procedure register in which a return address from a subroutine is stored when the subroutine is called.

4. The data processor according to claim 1,
wherein the predetermined data transfer instructions include register indirectly addressing mode, and
wherein a register used in the register indirectly addressing mode is incremented or decremented for each transfer between the register and memory.

5. The data processor according to claim 4,
wherein a register used in the register indirectly addressing mode is a stack pointer.

6. The data processor according to claim 1,
wherein the predetermined data transfer instructions are 16-bit instructions.

7. The data processor according to claim 1,
wherein the predetermined data transfer instructions include a first store instruction specifying data transfers to memory from registers corresponding to numbers equal to or greater than a number specified in a register specification field as a starting point.

8. The data processor according to claim 1,
wherein the predetermined data transfer instructions include a first load instruction specifying data transfers from memory to registers corresponding to numbers equal to or greater than a number specified in a register specification field as a starting point.

9. The data processor according to claim 1,
wherein the predetermined data transfer instructions include a second store instruction specifying data transfers to memory from registers corresponding to numbers equal to or smaller than a number specified in a register specification field as a starting point.

10. The data processor according to claim 1,
wherein the predetermined data transfer instructions include a second load instruction specifying data transfers from memory to registers corresponding to numbers equal to or smaller than a number specified in a register specification field as a starting point.

11. A data processor including an instruction control part for decoding instructions and controlling instruction execution sequences, and a plurality of registers,
wherein the instruction control part, when decoding a number specified in a register specification field of plural bits paired with specific operation code, controls data transfers between a group of registers corresponding to numbers equal to or greater than, or equal to or smaller than the number, and memory.

12. The data processor according to claim 11,
wherein the instruction control part can change the correspondence between numbers specifiable in the register specification field and registers according to setting states of a control register.

13. The data processor according to claim 11,
wherein a group of registers specifiable by numbers of the register specification field includes general purpose registers.

14. The data processor according to claim 13,
wherein the group of registers includes one or plural registers selected from a group of special-purpose registers other than general purpose registers within the data processor.
